(19) United States
(12) Patent Application Publication
(10) Pub. No.: US 2026/0204702 A1
(43) Pub. Date: Jul. 16, 2026

(54) Secondary Battery and Secondary Battery Manufacturing Method

(71) Applicant: SK On Co., Ltd., Seoul (KR)

(72) Inventors: Hak Bong MUN, Daejeon (KR); Jae Gyu BYUN, Daejeon (KR); Moon Hyung JUNG, Daejeon (KR); Seung Won CHOI, Daejeon (KR)

(21) Appl. No.: 19/444,413

(22) Filed: Jan. 9, 2026

(30) Foreign Application Priority Data
Jan. 10, 2025 (KR) 10-2025-0004118

(51) Int. Cl. H01M 50/169; H01M 10/04; H01M 10/052; H01M 50/627

(52) U.S. Cl. CPC H01M 50/169; H01M 10/049; H01M 10/052; H01M 50/627

(57) ABSTRACT

According to various embodiments of the present disclosure, a secondary battery comprises: a battery can including a side wall; and a cover cap coupled to one side of the side wall. At least a partial section of the cover cap is disposed to overlap the side wall in a radial direction to form an overlapping region, and the cover cap and the battery can are coupled in the overlapping region.

### CROSS-REFERENCE TO RELATED APPLICATION

This patent application claims the priority and benefits of Korean patent application No. 10-2025- 0004118, filed on January 10, 2025, the disclosure of which is incorporated herein by reference in its entirety.

### BACKGROUND OF THE INVENTION

1. Field of the Invention

The present disclosure relates to a secondary battery and a method for manufacturing a secondary battery.

2. Description of the Related Art

Various types of secondary batteries are used as energy sources in electric vehicles or electronic devices. In the secondary batteries, a jelly-roll-type electrode assembly, in which an anode plate, a cathode plate and a separator are wound together, is used, or alternatively, an electrode assembly fabricated by stacking an anode plate, a cathode plate, and a separator in an appropriate order may be used.

This electrode assembly is accommodated in a battery housing and connected to an anode terminal and a cathode terminal. The housing is then sealed after being filled with an electrolyte.

### SUMMARY OF THE INVENTION

An object of the present disclosure is to provide a secondary battery and a method for manufacturing a secondary battery that may improve the space efficiency and sealability of a battery can.

A secondary battery according to various embodiments of the present disclosure may comprise: a battery can including a side wall; and a cover cap coupled to one side of the side wall, wherein at least a partial section of the cover cap may be disposed to overlap the side wall in a radial direction to form an overlapping region, and the cover cap and the battery can may be coupled in the overlapping region.

In exemplary embodiments, the cover cap may comprise a body part disposed to cover an opening formed in one side of the side wall, and an edge part extending from the body part and disposed to overlap the side wall.

In exemplary embodiments, the overlapping region may be formed by the edge part and the side wall being arranged parallel to each other in an axial direction.

In exemplary embodiments, an upper end of the side wall may be axially spaced from the body part.

In exemplary embodiments, the side wall may comprise a first portion disposed to overlap at least a partial section of the edge part, and a second portion having a diameter larger than that of the first portion and formed in a stepped structure from the first portion.

In exemplary embodiments, the cover cap may be fitted to the first portion.

In exemplary embodiments, the overlapping region may be formed by surface contact between at least a portion of an inner circumferential surface of the edge part and at least a portion of an outer circumferential surface of the first portion, and the cover cap and the battery can may be joined to each other by welding on a radially outer side of the overlapping region.

In exemplary embodiments, the side wall may comprise a guide part extending from an upper end of the first portion and curved toward a central axis of the battery can as it approaches the body part.

In exemplary embodiments, the side wall may comprise a connection portion connecting the first portion and the second portion, and the edge part may be restricted from downward movement by the connection portion.

In exemplary embodiments, an inner diameter of the edge part may be formed to be equal to or smaller than an outer diameter of the first portion.

In exemplary embodiments, an inner diameter of the edge part may be formed to be larger than an outer diameter of an end of the guide part.

In exemplary embodiments, the secondary battery may comprise an electrode assembly disposed on an inner side of the side wall, and a retaining member disposed between the electrode assembly and the cover cap to support the electrode assembly.

In exemplary embodiments, the retaining member may electrically connect the electrode assembly to the cover cap.

In exemplary embodiments, the retaining member may comprise an electrode connection part coupled to an upper end of the electrode assembly, and a cap connection part protruding from the electrode connection part and coupled to the body part.

In exemplary embodiments, at least a partial section of an edge of the electrode connection part may be disposed to support an inner circumferential surface of the first portion.

In exemplary embodiments, the cap connection part may comprise a support wall protruding axially upward from the electrode connection part, and a support plate disposed at an upper end of the support wall and connected to the body part.

In exemplary embodiments, a first electrolyte injection port penetrating vertically may be formed on one side of the body part, and a second electrolyte injection port communicating with the first electrolyte injection port may be formed on one side of the support plate.

A method for manufacturing a secondary battery according to various embodiments of the present disclosure may comprise: an electrode assembly insertion step of inserting an electrode assembly into a battery can; a step portion forming step of forming a step portion having different diameters with respect to a side wall of the battery can; an overlapping region forming step of forming an overlapping region by coupling a cover cap to a first portion of the step portion; and a sealing step of welding the overlapping region to seal the cover cap and the battery can.

In exemplary embodiments, in the sealing step, the cover cap and the battery can may be joined to each other by welding on a radially outer side of the overlapping region.

In exemplary embodiments, the method may further comprise: a retaining member insertion step of disposing a retaining member on an upper portion of the electrode assembly inside the battery can; and an electrode fixing step of coupling the retaining member and the cover cap.

According to various embodiments of the present disclosure, by forming an overlapping region in a partial section of the side wall of the battery can that extends in the axial direction, a sufficient welding area may be secured and the sealing strength of the battery can may be increased.

In the present disclosure, beading and crimping parts of the battery can may be eliminated, thereby increasing the space efficiency inside the battery can.

In the present disclosure, the cover cap is fitted to the battery can while forming an overlapping region parallel to the axial direction, so that a primary fixing force may be applied to the cover cap.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a cross-sectional view schematically illustrating a secondary battery according to some embodiment of the present disclosure;

FIG. 2 is a perspective view illustrating a cover cap according to some embodiment of the present disclosure, as viewed from below;

FIG. 3 is a perspective view illustrating a retaining member as a movement prevention member according to some embodiment of the present disclosure, as viewed from above;

FIG. 4 is a cross-sectional view schematically illustrating a secondary battery according to another embodiment of the present disclosure;

FIG. 5 is a perspective view illustrating a cover cap according to another embodiment of the present disclosure, as viewed from below;

FIG. 6 is a perspective view illustrating a retaining member according to another embodiment of the present disclosure, as viewed from above;

FIG. 7 is a view illustrating a state in which a step portion is not formed on a side wall of the battery can in some embodiment of the present disclosure;

FIG. 8 is a view illustrating a state in which a step portion is formed on the side wall of the battery can in some embodiment of the present disclosure;

FIG. 9 is a view illustrating a state in which the retaining member is coupled to an upper portion of an electrode assembly in some embodiment of the present disclosure;

FIG. 10 is a view illustrating a state in which a cover cap is coupled to a first portion of the battery can in some embodiment of the present disclosure;

FIG. 11 is a cross-sectional view schematically illustrating a state in which the battery can and the cover cap are coupled according to some embodiment of the present disclosure; and

FIG. 12 is a flowchart illustrating a method for manufacturing a secondary battery according to some embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may comprise the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, a secondary battery 1 according to various embodiments of the present disclosure will be described in detail with reference to the accompanying drawings.

The secondary battery 1 described in the present disclosure may be any type of conventional battery cell capable of converting the chemical energy of materials stored in the battery into electrical energy, and capable of supporting multiple charge/discharge cycles.

In describing various embodiments of the present disclosure, the axial direction may refer to a direction in which a central axis of a battery can 100 extends, and the radial direction may refer to a direction extending toward or away from the above-described central axis. In addition, since a jelly-roll-shaped electrode assembly 200 is coaxially aligned with the battery can 100, the axial direction may also refer to a direction parallel to the central axis along which the electrode assembly 200 is wound.

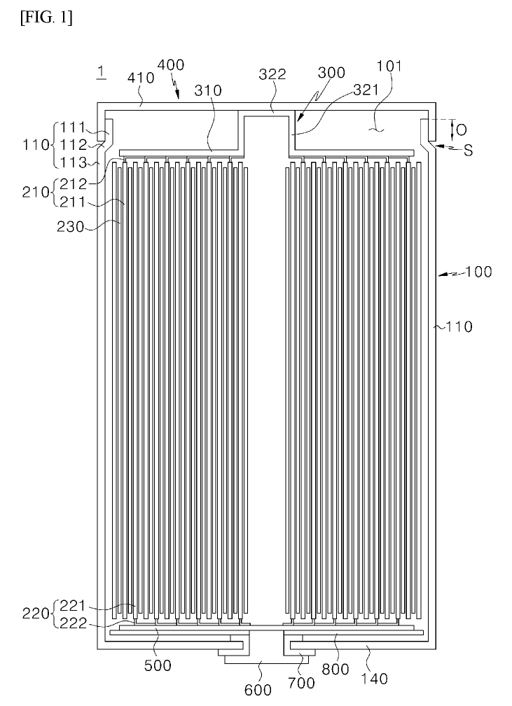

FIG. 1 is a cross-sectional view schematically illustrating the secondary battery 1 according to some embodiment of the present disclosure.

Referring to FIG. 1, the secondary battery 1 according to some embodiment of the present disclosure may comprise an electrode assembly 200, the battery can 100, a cover cap 400, and a retaining member 300.

In addition, the secondary battery may further comprise a current collector plate 500, an electrode terminal 600, a terminal gasket 700, and an insulator 800.

First, the electrode assembly 200 may comprise a first electrode 210, a second electrode 220, and a separator 230. The first electrode 210 and the second electrode 220 may each comprise a current collector and a coating layer formed on the current collector and having an active material coated thereon.

The first electrode 210 may be either a cathode or an anode. For example, the first electrode 210 may be an anode. In some embodiment, the first electrode 210 may comprise a first current collector (not shown) in the form of a metal foil and a first coating layer 211 on which an anode active material is coated. For example, the first current collector may be an anode current collector and may comprise copper or nickel.

In some embodiment, the first coating layer 211 may be an electrically conductive coating layer serving as the first coating layer 211. The first coating layer 211 may comprise an anode active material. For example, the anode active material may comprise a silicon material (e.g., metallic silicon and silicon dioxide), a carbon-based material (e.g., graphite materials, graphene-containing materials, hard carbon, soft carbon, carbon nanotubes, porous carbon, conductive carbon), a tin-based material, or a metal oxide, but is not limited thereto. Any anode active material known to those skilled in the art may be used.

The first current collector may comprise a first uncoated part 212 on which no first coating layer 211 is formed. For example, the first uncoated part 212 may be an anode uncoated part and may serve as an anode tab.

The first uncoated part 212 may be exposed to one side in the axial direction of the electrode assembly 200. For example, the first uncoated part 212 may protrude from the electrode assembly 200 toward the cover cap 400.

The first uncoated part 212 may be electrically connected to the cover cap 400, described below. For example, the first uncoated part 212 may be directly connected to the cover cap 400 by a method such as laser welding.

In the present disclosure, since it is not necessary to form a beading part on the battery can 100 when coupling the cover cap 400 to the battery can 100, the space efficiency inside the battery can 100 may be improved by directly coupling the first uncoated part 212 to the cover cap 400, thereby further increasing the energy density. However, it is not limited thereto, and the first uncoated part 212 may also be coupled to the cover cap 400 through a separate connecting member.

According to some embodiment of the present disclosure, the first uncoated part 212 may be electrically connected to the cover cap 400 through the retaining member 300 described below. That is, the first uncoated part 212 may be electrically connected to the cover cap 400 by being in contact with and coupled to the retaining member 300 disposed between the electrode assembly 200 and the cover cap 400. A detailed description thereof will be provided below.

The second electrode 220 may be either a cathode or an anode. When the first electrode 210 is an anode, the second electrode 220 may be a cathode, and when the first electrode 210 is a cathode, the second electrode 220 may be an anode.

In some embodiment, the second electrode 220 may be a cathode. The second electrode 220 may comprise a second current collector (not shown) in the form of a metal foil and a second coating layer 221 formed by applying a cathode active material to the cathode current collector. For example, the second current collector may be a cathode current collector and may comprise aluminum.

In some embodiment, the second coating layer 221 may be an electrically conductive coating serving as a cathode coating layer. The second coating layer 221 may comprise a cathode active material. For example, the cathode active material may comprise lithium nickel manganese cobalt oxide (NMC), lithium manganese oxide (LMO), lithium iron phosphate (LFP), lithium cobalt oxide (LCO), lithium titanate (LTO), or a chalcogenide compound (such as LiTiS₂), but it is not limited thereto, and any cathode active material known to those skilled in the art may be used.

The second current collector may comprise a second uncoated part 222 on which no second coating layer 221 is formed. For example, the second uncoated part 222 may be a cathode uncoated part and may serve as a cathode tab.

The second uncoated part 222 may be exposed to the other side in the axial direction of the electrode assembly 200, so as to be disposed opposite the first uncoated part 212. For example, the second uncoated part 222 may protrude from the electrode assembly 200 in a direction opposite the cover cap 400.

The second uncoated part 222 may be electrically connected to the electrode terminal 600 described below. In this case, the second uncoated part 222 may not be electrically connected to the battery can 100. For example, the second uncoated part 222 may be connected to the electrode terminal 600 through the current collector plate 500. However, it is not limited thereto, and the second uncoated part 222 may be directly connected to the electrode terminal 600 by a method such as welding.

The separator 230 may be interposed between the first electrode 210 and the second electrode 220 to prevent the first electrode 210 and the second electrode 220 from being electrically connected to each other and causing a short circuit. For example, the separator 230 may comprise an electrically insulating material. For example, the separator 230 may comprise a polymeric material. For example, the separator 230 may comprise polyethylene, polypropylene, or a combination thereof, but it is not limited thereto.

In the present disclosure, a tabless structure may be used in which the uncoated parts of the first electrode 210 and the second electrode 220 serve as electrode tabs without the need for separate electrode tabs, but is not limited thereto, and it is obvious that a structure in which separate electrode tabs are connected to the first electrode 210 and the second electrode 220 may also be employed.

The battery can 100 may have an opening 101 formed at least one axial end thereof so that the electrode assembly 200 can be accommodated through the opening of the battery can 100. In this case, the upper end region of the side wall 110 forming the opening 101 may be described as an open end part 1101.

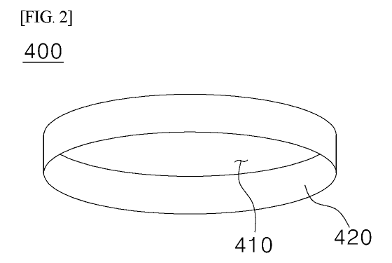

The battery can 100 have an internal space formed therein to accommodate the electrode assembly 200. In this case, as an example, an upper end of the battery can 100 is described as being open as shown in FIG. 2, but it is obvious that the opposite configuration may also be employed.

The battery can 100 may comprise a conductive metal material. The battery can 100 may be electrically connected to either the first electrode 210 or the second electrode 220. For example, the battery can 100 may be electrically connected to the first electrode 210 and may have the same polarity as the first electrode 210. However, it is not limited thereto, and the battery can 100 may be configured to be electrically insulated from the first electrode 210 or the second electrode 220.

The shape of the battery can 100 may be determined to correspond to the specific shape of the electrode assembly 200. For example, the battery can 100 may be cylindrical or have a rectangular parallelepiped structure.

The battery can 100 may comprise the opening 101 formed at an upper axial end, a lower wall 140 formed at an axial end opposite the opening 101, and a side wall 110 connecting the opening 101 and the lower wall 140.

The side wall 110 may comprise a step portion S formed in a stepped structure by at least a partial section having different diameters.

In some embodiment, the side wall 110 may comprise a first portion 111 formed to have a first diameter adjacent to the opening 101, a second portion 113 disposed below the first portion 111 and formed to have a diameter larger than the first diameter, and a connection portion 112 connecting the first portion 111 and the second portion 113. In this case, a section connected in a stepped structure, including the first portion 111, the connection portion 112, and the second portion 113, may be referred to as the step portion S.

The step portion S may be formed at a position adjacent to the opening 101 to which the cover cap 400 is coupled. For example, the step portion S may be formed in an upper section of the electrode assembly 200. In the present disclosure, by forming the step portion S on the side wall 110, the cover cap 400 may be easily coupled to the side wall 110, and a stable welding surface may be formed.

First, the side wall 110 may comprise the first portion 111 formed to have the first diameter. In this case, the first diameter may refer to the outer diameter of the first portion 111.

For example, the first portion 111 may be formed in a section including the open end part 1101 of the side wall 110. The first portion 111 may extend in the axial direction from the open end part 1101 of the side wall 110 to a predetermined height.

Alternatively, the first portion 111 may extend in the axial direction from a section spaced a predetermined distance from the open end part 1101 of the side wall 110 to a predetermined height. For example, a guide part 115, described below, may be formed at the open end part 1101 of the side wall 110 where the first portion 111 is not formed.

For example, a lower end of the first portion 111 may be positioned at a height that improves internal space efficiency while also ensuring sufficient bonding strength by welding.

The cover cap 400, described below, may be coupled to the first portion 111 of the side wall 110. For example, the cover cap 400 may be fitted to the first portion 111.

An inner circumferential surface of an edge part 420 of the cover cap 400 may be disposed to face an outer circumferential surface of the first portion 111. An inner circumferential surface of the edge part 420 may be arranged in surface contact with the outer circumferential surface of the first portion 111.

In some embodiment, at least a portion of the retaining member 300 may be disposed inside the first portion 111. For example, the retaining member 300 may be disposed at a predetermined radial distance from the first portion 111. For example, when the first portion 111 is deformed radially inward during the process of coupling the cover cap 400 to the first portion 111, the retaining member 300 located on the inner side may support the first portion 111, thereby minimizing deformation.

In the present disclosure, the first portion 111 of the side wall 110 and the edge part 420 of the cover cap 400 may be fitted together, and at least a partial section of an outer circumferential surface of the first portion 111 and at least a partial section of the inner circumferential surface of the edge part 420 may be in surface contact. In this case, in a section where the outer circumferential surface of the first portion 111 and the inner circumferential surface of the edge part 420 are in surface contact, an overlapping region O, in which the first portion 111 and the edge part 420 overlap in the radial direction, may be formed. The cover cap 400 and the side wall 110 may be welded to each other in the overlapping region O, thereby securing a sufficient welding area.

The side wall 110 may comprise the second portion 113 formed to have a second diameter larger than the first diameter. In this case, the second diameter may refer to the outer diameter of the second portion 113. Accordingly, the outer diameter of the second portion 113 may be formed to be greater than the outer diameter of the first portion 111.

The second portion 113 may be disposed below the first portion 111 and may extend axially downward from a lower end of the connection portion 112. For example, the second portion 113 may refer to the entire section extending from the lower end of the connection portion 112 to the lower wall 140, but is not limited thereto, and may also refer to a partial section extending from the lower end of the connection portion 112. The electrode assembly 200 may be disposed inside the second portion 113.

The side wall 110 may comprise the connection portion 112 disposed between the first portion 111 and the second portion 113. The connection portion 112 may extend to connect the first portion 111 and the second portion 113 having different diameters. The connection portion 112 may extend to connect the lower end of the first portion 111 and an upper end of the second portion 113.

The connection portion 112 may be formed to slope radially outward from the lower end of the first portion 111 toward the downward direction. For example, the connection portion 112 may be formed to slope such that its outer diameter increases downward from the lower end of the first portion 111.

Alternatively, the lower end of the first portion 111 and the upper end of the second portion 113 may be formed at the same height, and the connection portion 112 may extend horizontally and radially outward from the lower end of the first portion 111.

In the present disclosure, since the connection portion 112 is disposed to connect the second portion 113, which has a larger outer diameter than the first portion 111, from the lower end of the first portion 111, the outer diameter of the connection portion 112 is formed to be larger than that of the first portion 111. Accordingly, the lower end of the edge part 420 of the cover cap 400, which is coupled to the first portion 111, may be restricted from downward movement by the connection portion 112. That is, in some embodiment of the present disclosure, the connection portion 112 may serve as a stopper that restricts the downward movement of the cover cap 400.

In some embodiment, the first portion 111 of the side wall 110 may be formed to have a reduced diameter at an upper partial section of the side wall 110 through a swaging process. However, this is merely an example, and the first portion 111 may also be formed so that the outer diameter of the upper partial section of the side wall 110 is reduced through cutting or machining.

In addition, according to some embodiment, the battery can 100 may be prepared with the step portion S formed to comprise the first portion 111, the connection portion 112, and the second portion 113, and the electrode assembly 200 may then be inserted therein.

The battery can 100 may comprise the lower wall 140 disposed below the electrode assembly 200 and extending from a lower portion of the side wall 110. The electrode terminal 600 may be disposed on the lower wall 140 of the battery can 100. For example, a terminal hole may be formed in the lower wall 140 through which the electrode terminal 600 is inserted. The lower wall 140 may be electrically insulated from the second electrode 220 of the electrode assembly 200.

Hereinafter, the structure of the secondary battery 1 on a lower side of the electrode assembly 200 will be described first.

The electrode terminal 600 may be disposed on the lower wall 140 of the battery can 100. For example, the electrode terminal 600 may be disposed by passing through the terminal hole formed in the lower wall 140 of the battery can 100.

The electrode terminal 600 may be electrically insulated from the lower wall 140 of the battery can 100. For example, in the present disclosure, the electrode terminal 600 may be electrically insulated from the lower wall 140 of the battery can 100 through the terminal gasket 700 disposed between the electrode terminal 600 and the lower wall 140. The electrode terminal 600 and the battery can 100 may have different polarities.

The electrode terminal 600 may be electrically connected to the second electrode 220. For example, the electrode terminal 600 may be a cathode terminal. For example, the electrode terminal 600 may be directly connected to the second electrode 220, or may be connected to the second electrode 220 through the current collector plate 500.

In some embodiment, an upper portion of the electrode terminal 600 may be connected to the current collector plate 500 through a hollow portion of the insulator 800, and a lower portion of the electrode terminal 600 may be exposed to and fixed outside of the battery can 100.

FIG. 1 illustrates the electrode terminal 600 as having a rivet shape, but this is merely an example. The specific shape of the electrode terminal 600 is not limited thereto, and it is apparent that any known form of electrode terminal 600 may be applied.

The current collector plate 500 may be disposed adjacent to the lower portion of the electrode assembly 200 inside the battery can 100. The current collector plate 500 may be electrically connected to the second electrode 220 to provide a pathway for electron migration. For example, the second electrode 220 may be a cathode, and the current collector plate 500 may serve as a cathode current collector plate 500.

For example, the current collector plate 500 may be arranged so as to be electrically connected to an uncoated part of the second electrode 220. The current collector plate 500 may be connected by directly contacting the second uncoated part 222 of the second electrode 220, but is not limited thereto, and may also be connected through a separate conductive member.

The current collector plate 500 may be electrically connected to the electrode terminal 600. The current collector plate 500 may be electrically connected to the upper portion of the electrode terminal 600 and the second electrode 220 of the electrode assembly 200 to provide a pathway for electron migration.

The current collector plate 500 may be provided in a shape corresponding to a lower surface of the electrode assembly 200. For example, the current collector plate 500 may be a circular metal plate.

The current collector plate 500 may be disposed to be electrically insulated from the battery can 100, and the current collector plate 500 and the battery can 100 may have different polarities. The current collector plate 500 may be electrically insulated from the battery can 100 by the insulator 800.

The insulator 800 may be disposed to electrically insulate the battery can 100. The secondary battery 1 may electrically insulate the current collector plate 500 from the battery can 100 by interposing the insulator 800 between the current collector plate 500 and the battery can 100.

The insulator 800 may be disposed between the current collector plate 500 and the lower wall 140 of the battery can 100, thereby preventing the current collector plate 500 from contacting the lower wall 140 or the side wall 110 of the battery can 100.

Alternatively, if the current collector plate 500 is omitted and the electrode terminal 600 is directly connected to the second uncoated part 222, the insulator 800 may be disposed between the uncoated part of the second electrode 220 of the electrode assembly 200 and the lower wall 140 of the battery can 100.

For example, the insulator 800 may have a hollow circular plate shape. The electrode terminal 600 may be electrically connected to the current collector plate 500 by passing the insulator 800 through the hollow portion of the insulator 800.

In some embodiment, the insulator 800 may be omitted depending on the configuration of the electrode terminal 600.

Next, the structure of the secondary battery 1 on an upper side of the electrode assembly 200 will be described in detail.

In the secondary battery 1 of the present disclosure, an electrolyte may be inserted into the battery can 100 together with the electrode assembly 200 during the manufacturing process. In this case, the electrolyte serves as a medium for the migration of lithium ions between the second electrode 220 and the first electrode 210 forming the electrode assembly 200. For example, the electrolyte may be a non-aqueous organic electrolyte that is a mixture of a lithium salt and a high-purity organic solvent. For example, the electrolyte may be a polymer using a polymer electrolyte or solid electrolyte.

The opening 101 of the battery can 100, into which the electrode assembly 200 and the electrolyte are inserted, may be sealed by the cover cap 400.

The conventional battery can 100 comprises a beaded part formed by recessing a partial section of the side wall 110 of the battery can 100 inward toward the center after the electrode assembly 200 is received therein.

In the structure of the conventional secondary battery 1, the beading part was used to apply a physical fixing force to the electrode assembly 200 accommodated inside the battery can 100, while serving as a means to seat the cover cap 400.

In addition, conventionally, a method of mechanically sealing the battery can 100 was used by forming a crimping part F. This was done by bending the open end part 1101 of the battery can 100 inward while the cover cap 400 was seated on the beading part, so that the open end part 1101 and the cover cap 400 came into close contact with each other. In this case, during applying a downward pressing force to bend the open end part 1101 of the battery can 100 using a crimping mold, a downward pressing force is simultaneously applied to both the open end part 1101 of the battery can 100 and the cover cap 400.

Therefore, the conventional beading part was also used as a means of supporting the downward pressing force applied by the crimping mold during the crimping process.

However, since the beading part is formed by inwardly recessing the side wall 110 of the battery can 100, the internal space efficiency of the battery can 100 is reduced by the portion of the side wall 110 that is recessed. In other words, in the conventional secondary battery 1, it was difficult to efficiently utilize the internal space of the battery can 100 due to the beading part, which made it difficult to increase the energy density of the secondary battery 1.

In general, when the beading part is omitted from the battery can 100, it becomes difficult to couple the cover cap 400 through the crimping process. Therefore, sealing strength is sometimes secured by welding the cover cap 400 instead. However, in the absence of the beading part, only axial welding can be performed on the cover cap 400, making it difficult to secure a sufficient welding area and ensure adequate sealing strength of the battery can 100. In addition, in conventional structures, because it is difficult to secure a sufficient welding area when welding the cover cap 400 to the battery can 100, problems such as reduced weld strength or electrolyte leakage may occur.

Accordingly, the present disclosure proposes a coupling structure between the battery can 100 and the cover cap 400 that can enhance sealing strength by omitting the beading part of the battery can 100 while securing a sufficient welding area between the battery can 100 and the cover cap 400.

The structure of the secondary battery 1 that can achieve sealing strength through a sufficient welding area without forming a bead part in the battery can 100 according to various embodiments of the present disclosure will now be described in detail.

FIG. 2 is a perspective view illustrating the cover cap 400 according to some embodiment of the present disclosure, as viewed from below.

First, the cover cap 400 according to some embodiment of the present disclosure will be described in detail with reference to FIGS. 1 and 2.

According to some embodiment of the present disclosure, the secondary battery 1 may comprise the cover cap 400 coupled to the opening 101 of the battery can 100.

In some embodiment, the secondary battery 1 may be sealed by coupling the cover cap 400 to the opening 101 after the electrolyte has been injected into the battery can 100.

Alternatively, in some embodiment, the electrode assembly 200 may be inserted into the battery can 100, and the electrolyte may then be injected while the cover cap 400 is coupled to the opening 101.

The cover cap 400 may be coupled to the opening 101 of the battery can 100 to seal the opening 101 of the battery can 100. The cover cap 400 may be formed of a conductive metal metal.

The cover cap 400 may be electrically connected to the first electrode 210 and have the same polarity as the first electrode 210. For example, the first electrode 210 may be an anode, and the cover cap 400 may serve as an anode terminal.

In addition, the cover cap 400 may be electrically connected to the battery can 100. The cover cap 400 may be electrically connected to the battery can 100 by being welded to the first portion 111 of the battery can 100 through the edge part 420, as described below.

In some embodiment, the cover cap 400 may comprise a body part 410 disposed to cover the opening 101 of the battery can 100, and the edge part 420 that extends from the body part 410 to cover the side wall 110.

The body part 410 may be disposed to cover the opening 101 of the battery can 100. The body part 410 may be disposed to have a shape and area corresponding to those of the opening 101. For example, the body part 410 may be provided in a circular plate shape.

The body part 410 of the cover cap 400 may be electrically connected to the first uncoated part 212 of the first electrode 210. For example, the body part 410 may be directly connected to the first uncoated part 212, or may be connected to the first uncoated part 212 through the retaining member 300.

In some embodiment, a lower surface of the body part 410 may be in contact with the retaining member 300. For example, the lower surface of the body part 410 may be in surface contact with a cap connection part 320 of the retaining member 300.

The body part 410 may be coupled to the cap connection part 320. For example, the body part 410 may be joined to the cap connection part 320 by welding while the lower surface of the body part 410 and the upper surface of the cap connection part 320 are in surface contact. Alternatively, the body part 410 may be joined through a conductive bonding member disposed between the lower surface of the body part 410 and the upper surface of the cap connection part 320.

The body part 410 may be coupled to the cap connection part 320 to provide a support force to the electrode assembly 200 in a direction perpendicular to the axial direction. In addition, the body part 410 may apply a downward pressing force to the electrode assembly 200 through the retaining member 300 while the edge part 420 is coupled to the first portion 111 of the battery can 100.

The lower surface of the body part 410 may be spaced apart from an upper surface of the side wall 110 of the battery can 100. Since the body part 410 is spaced apart from the upper surface of the side wall 110, the cover cap 400 may not apply a downward pressing force to the side wall 110 during coupling to the open end part 1101 of the battery can 100. Therefore, in the present disclosure, deformation of the side wall 110 may be prevented during the process of coupling the cover cap 400 to the open end part 1101.

In some embodiment, the body part 410 may comprise at least one protrusion (not shown). The protrusion may be disposed to protrude axially upward from one side of the body part 410. For example, the protrusion may be disposed coaxially with the central axis of the battery can 100 on the body part 410, but is not limited thereto. The secondary battery 1 of the present disclosure may facilitate contact with an external component (e.g., a bus bar, not shown) through the protrusion and provide a pathway for electron migration.

In some embodiment, at least one notch (not shown) may be formed on one side of the body part 410 to facilitate rupture of the battery can 100 when the internal pressure increases. For example, the notch may be formed in the form of a groove recessed to a predetermined depth on at least one of the upper or lower surfaces of the body part 410. The notch may also be formed on the protrusion, but is not limited thereto.

The edge part 420 may extend axially downward from the edge of the body part 410. Alternatively, the edge part 420 may be formed by bending a portion of the edge of the body part 410 axially downward along the circumference.

The edge part 420 may extend a predetermined length from the edge of the body part 410. For example, the edge part 420 may be formed longer than the axial length of the first portion 111 of the side wall 110.

The edge part 420 of the cover cap 400 may be coupled to the first portion 111 of the side wall 110. For example, the edge part 420 may be fitted to the first portion 111.

At least a partial section of the edge part 420 may be disposed to overlap the first portion 111 of the side wall 110 in the radial direction. At least a portion of the inner surface of the edge part 420 may be in surface contact with at least a partial section of the outer surface of the first portion 111. In the secondary battery 1 according to some embodiment of the present disclosure, a section where the inner surface of the edge part 420 and the outer surface of the first portion 111 are in surface contact may be described as the overlapping region O. In this case, the overlapping region O formed between the cover cap 400 and the battery can 100 may also be described as a first overlapping region O.

In some embodiment, the lower end of the edge part 420 may be positioned at a height corresponding to the lower end of the first portion 111. For example, the lower end of the edge part 420 may be disposed in contact with one side of the outer surface of the connection portion 112. The cover cap 400 may restrict downward movement as the lower end of the edge part 420 comes into contact with the connection portion 112 extending obliquely from the lower end of the first portion 111.

In some embodiment, the lower end of the edge part 420 may be positioned at a height corresponding to an arbitrary height of the first portion 111 without contacting the outer surface of the connection portion 112.

In still some embodiment, the lower end of the edge part 420 may be positioned at a height corresponding to an arbitrary height of the connection portion 112 without contacting the outer surface of the connection portion 112.

An inner diameter of the edge part 420 may be formed to be equal to or smaller than the outer diameter of the first portion 111. For example, the inner diameter of the edge part 420 in the overlapping region O may be formed to be equal to or smaller than the outer diameter of the first portion 111 in the overlapping region O. Therefore, in the present disclosure, the edge part 420 may be fitted to the first portion 111.

That is, in the present disclosure, by forming the overlapping region O in a partial section of the side wall 110 of the battery can 100 that extends in the axial direction, a sufficient welding area may be secured, and the sealing strength of the battery can 100 may be increased.

In some embodiment, to facilitate coupling between the edge part 420 and the first portion 111, an insertion portion (not shown) having an inner diameter equal to or larger than the outer diameter of the first portion 111 may be formed at least in a partial section of the lower end of the edge part 420. For example, the insertion portion may be formed to taper radially outward from the lower end of partial section of the edge part 420 that is in surface contact with the first portion 111.

In the present disclosure, the cover cap 400 may apply a support force to the electrode assembly 200 through the retaining member 300, thereby preventing the electrode assembly 200 from moving inside the battery can 100 in the axial direction or in a direction perpendicular to the axial direction.

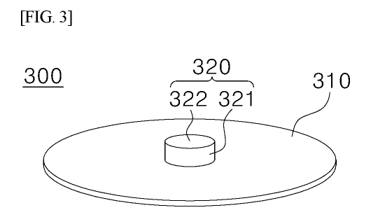

FIG. 3 is a perspective view illustrating the retaining member 300 according to some embodiment of the present disclosure, as viewed from above. Hereinafter, the retaining member 300 will be described in detail below with reference to FIGS. 1 and 3.

The secondary battery 1 according to some embodiment of the present disclosure may comprise the retaining member 300.

The retaining member 300 may be disposed between the electrode assembly 200 and the cover cap 400. The retaining member 300 may support the electrode assembly 200 inside the battery can 100, thereby preventing movement of the electrode assembly 200.

The retaining member 300 may be electrically connected to the first electrode 210 to provide a pathway for electron migration. The retaining member 300 may electrically connect the first electrode 210 to the cover cap 400.

In some embodiment, the retaining member 300 may comprise an electrode connection part 310 and the cap connection part 320.

The electrode connection part 310 may be coupled to the first uncoated part 212 of the first electrode 210. The electrode connection part 310 may be coupled by directly contacting the first uncoated part 212, or may be coupled through a separate conductive member. For example, the electrode connection part 310 may be coupled to the first uncoated part 212 by welding.

The electrode connection part 310 may be provided in a shape corresponding to an upper portion of the electrode assembly 200. For example, the electrode connection part 310 may be provided in a circular plate shape. For example, the electrode connection part 310 may be formed to have a predetermined thickness.

In some embodiment, at least a partial section of the electrode connection part 310 may be positioned at a height corresponding to at least a partial section of the first portion 111. The edge of the electrode connection part 310 may be disposed such that at least a partial section of the edge supports the inner circumferential surface of the first portion 111. In this case, even if deformation occurs in the first portion 111 of the side wall 110 during the fitting process of the cover cap 400, the electrode connection part 310 may minimize the deformation by supporting the first portion 111 from the inside.

In some embodiment, the electrode connection part 310 may be positioned at a height corresponding to an upper portion of the connection portion 112 of the side wall 110 or the second portion 113.

In some embodiment, the electrode connection part 310 may be disposed such that at least a portion of its periphery contacts the inner circumferential surface of the side wall 110. For example, at least a portion of the periphery of the electrode connection part 310 may be disposed such that it contacts the first portion 111 of the side wall 110, but is not limited thereto, and may also be disposed such that it contacts the second portion 113 or the connection portion 112. For example, by disposing at least a portion of the periphery of the electrode connection part 310 such that it contacts the side wall 110, alignment between a first electrolyte injection port 411 formed in the body part 410 of the cover cap 400 and the second electrolyte injection port 3221 formed in the cap connection part 320 may be easily secured.

The cap connection part 320 may be formed on one side of the electrode connection part 310 that protrudes toward the body part 410 of the cover cap 400. The cap connection part 320 may be disposed at the central portion of the body part 410 in the radial direction, but is not limited thereto. For example, the cap connection part 320 may be formed integrally with the electrode connection part 310.

The cap connection part 320 may comprise a support wall 321 that protrudes axially upward from the electrode connection part 310 and a support plate 322 that is disposed to cover an upper end of the support wall 321.

The support wall 321 may extend axially upward along the periphery of the electrolyte hole 311formed in the electrode connection part 310. For example, the support wall 321 may be disposed perpendicularly from the electrode connection part 310, but is not limited thereto, and may be formed to have an angle greater than or less than 90 degrees with respect to the electrode connection part 310.

The support wall 321 may be disposed to have a predetermined height and be connected to the body part 410. For example, the height of the support wall 321 may be formed to be equal to or higher than the first portion 111 of the battery can 100.

The support plate 322 may be disposed on the upper portion of the support wall 321, at least a portion of which is connected to the body part 410 of the cover cap 400. At least a partial section of the support plate 322 may be formed parallel to the body part 410.

For example, the support plate 322 may be disposed so that at least a portion thereof is in surface contact with the body part 410 of the cover cap 400. For example, the support plate 322 may be coupled by welding in a region where it is in surface contact with the body part 410. In this case, an overlapping region formed by the axial overlap of the support plate 322 and the body part 410 may be described as a second overlapping region. For example, the second overlapping region may refer to the region where the support plate 322 is in surface contact with the body part 410.

In the present disclosure, the retaining member 300 is coupled to both the cover cap 400 and the electrode assembly 200, thereby supporting the electrode assembly 200 to prevent movement within the battery can 100. For example, the retaining member 300 may apply a radial fixing force to the electrode assembly 200 by coupling the electrode connection part 310 and the upper portion (e.g., the first uncoated part 212) of the electrode assembly 200.

Furthermore, the retaining member 300 may apply an axial fixing force to the electrode assembly 200 through the support wall 321 extending from the electrode connection part 310 to the body part 410 of the cover cap 400.

In the embodiments of FIGS. 1 to 3 described above, after the electrode assembly 200 and the retaining member 300 are accommodated inside the battery can 100, the cover cap 400 may be coupled in a state where the electrolyte has been injected.

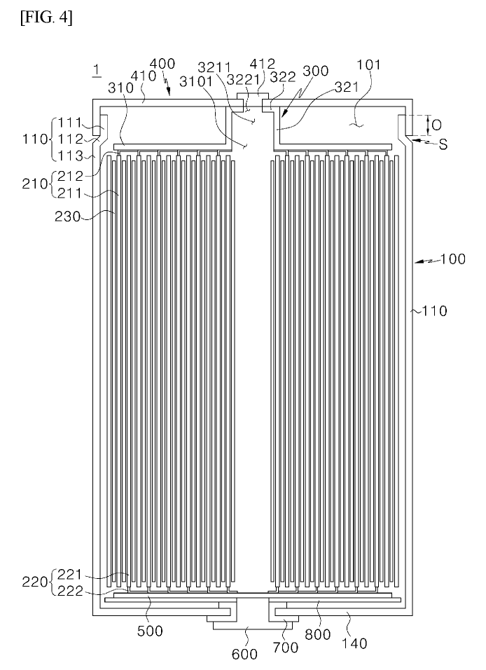

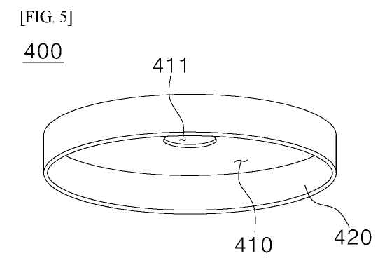

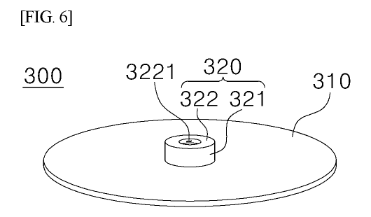

FIG. 4 is a schematic cross-sectional view illustrating a secondary battery 1 according to another embodiment of the present disclosure, FIG. 5 is a perspective view illustrating the cover cap 400 according to the embodiment of FIG. 4, as viewed from below, and FIG. 6 is a perspective view illustrating the retaining member 300 according to the embodiment of FIG. 4, as viewed from above.

The embodiment of FIG. 4 is identical to the embodiments of FIGS. 1 to 3 described above, except for the structure in which electrolyte injection ports are formed in the cover cap 400 and the retaining member 300, and therefore, a repeated description thereof will be omitted.

Referring to FIGS. 4 to 6, in some embodiment, the first electrolyte injection port 411 penetrating vertically may be formed in one side of the body part 410 of the cover cap 400. For example, the first electrolyte injection port 411 may be arranged in the center of the body part 410. For example, the first electrolyte injection port 411 formed in the body part 410 may be disposed to communicate with a second electrolyte injection port 3221 formed in the retaining member 300.

In some embodiment, the electrolyte may be injected into the battery can 100 through the first electrolyte injection port 411 of the body part 410 while the cover cap 400 is coupled to the battery can 100. In this case, when the electrolyte is injected into the battery can 100, a separate sealing member 412 may be coupled to the first electrolyte injection port 411 to seal the battery can 100.

In some embodiment, when the first electrolyte injection port 411 is formed in the body part 410, the cover cap 400 may further comprise the sealing member 412 configured to seal the first electrolyte injection port 411 after the electrolyte injection is completed.

In some embodiment, an electrolyte hole 3101 may penetrate vertically in the center of the electrode connection part 310 of the retaining member 300. The electrolyte hole 3101 communicates with an electrolyte flow path 3211 formed in the cap connection part 320 and may serve as a path through which the electrolyte flows into the lower portion of the electrode assembly 200.

In some embodiment, an electrolyte flow path 3211, through which the electrolyte may flow, may be formed on the inside the support wall 321 of the cap connection part 320. For example, the electrolyte flow path 3211 may be formed to communicate with the second electrolyte injection port 3221 formed in the support plate 322 and the electrolyte hole 3101 formed in the electrode connection part 310.

In some embodiment, the support plate 322 may comprise the second electrolyte injection port 3221 that penetrates vertically in the axial direction. For example, the second electrolyte injection port 3221 may be formed at the center of the support plate 322. For example, the second electrolyte injection port 3221 may be formed in a region where the support plate 322 is in surface contact with the body part 410 of the cover cap 400.

The second electrolyte injection port 3221 may be formed to communicate with the first electrolyte injection port 411 formed in the body part 410 of the cover cap 400. The second electrolyte injection port 3221 may be formed to communicate with the first electrolyte injection port 411 formed in the body part 410 of the cover cap 400 and the electrolyte flow path 3211 formed on the inner side of the support plate 322.

In some embodiment, the electrolyte may be injected into the battery can 100 through the first electrolyte injection port 411 of the cover cap 400, the second electrolyte injection port 3221 of the retaining member 300, and the electrolyte flow path 3211 while the cover cap 400 is coupled to the battery can 100.

In the above, it has been described that the retaining member 300 comprises a flow path structure through which the electrolyte injected through the first electrolyte injection port 411 formed in the cover cap 400 may flow, but this is some embodiment, and even when the electrolyte is injected after the cover cap 400 of the secondary battery 1 of the present disclosure is coupled, a flow path for the electrolyte may not be formed in the retaining member 300.

For example, when the electrolyte is injected before the cover cap 400 of the secondary battery 1 of the present disclosure is coupled, the cover cap 400 and the retaining member 300 may not have a structure formed to allow the electrolyte to be injected or to flow within the battery can 100, as described in the embodiments of FIGS. 1 to 3 above.

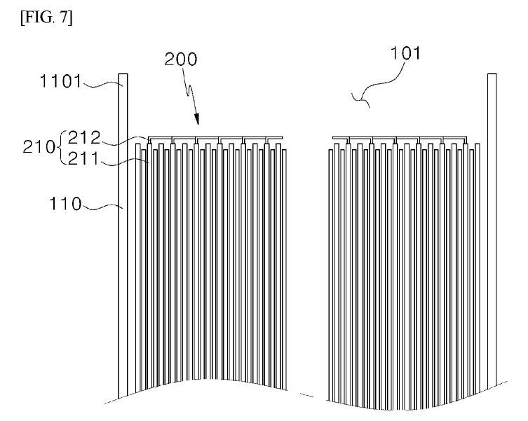

FIGS. 7 to 10 are cross-sectional views schematically illustrating the coupling process of the battery can 100 and the cover cap 400 in the secondary battery 1 according to exemplary embodiments of the present disclosure.

Hereinafter, a process for manufacturing the secondary battery 1 according to various embodiments of the present disclosure will be described in detail with reference to FIGS. 7 to 10.

FIG. 7 is a view illustrating a state in which the step portion S is not formed on the side wall 110 of the battery can 100.

Referring to FIG. 7, the battery can 100 may be prepared with the electrode assembly 200 inserted therein. In this case, the side wall 110 of the battery can 100 may not have the step portion S formed thereon. For example, the side wall 110 may be prepared to have the same diameter throughout the entire section, including the open end part 1101. For example, the battery can 100 may be provided so that the entire section of the side wall 110 has the second diameter described below.

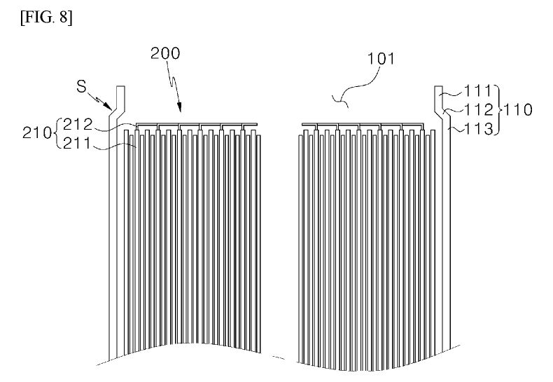

FIG. 8 is a view illustrating a state in which the step portion S is formed on the side wall 110 of the battery can 100.

Referring to FIG. 8, the secondary battery 1 of the present disclosure may have the step portion S formed on the side wall 110 of the battery can 100. The step portion S may be formed on the side wall 110 of the battery can 100 so that each section has a different diameter.

In some embodiment, the step portion S may be formed by reducing the diameter of a partial section of the upper portion of the side wall 110. For example, the step portion S may be formed by reducing the upper partial section of the side wall 110, including the open end part 1101, of the battery can 100, which is prepared so that the entire section has a second diameter, to have a first diameter smaller than the remaining lower section.

In the present disclosure, the “step portion S” may be used as a term to describe a portion of the side wall 110 where the diameter changes. For example, the step portion S may be described as a portion of the entire side wall 110 that comprises the connection portion 112, and the first portion 111 and the second portion 113 adjacent to the connection portion 112.

For example, the step portion S may be formed through a swaging process, but is not limited thereto, and may be fabricated using any forming method known at the time of filing.

For example, the step portion (S) may be formed at a position that is equal to or higher than the upper portion of the electrode assembly 200. Accordingly, even if the upper portion of the side wall 110 of the secondary battery 1 is reduced in diameter, interference between the battery can 100 and the electrode assembly 200 may be prevented.

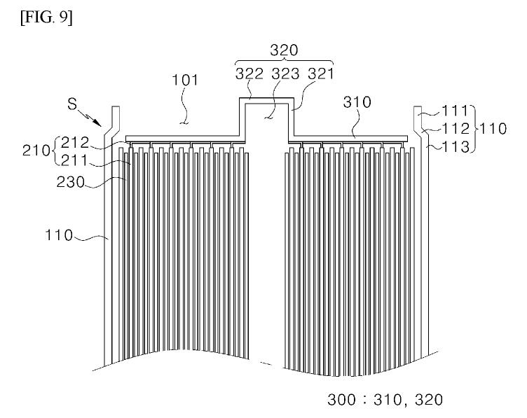

FIG. 9 is a view illustrating a state in which the retaining member 300 is coupled to the upper portion of the electrode assembly 200.

Referring to FIG. 9, the retaining member 300 may be disposed at the upper portion of the electrode assembly 200. For example, the retaining member 300 may be disposed so as to contact the first uncoated part 212 of the first electrode 210, and the electrode connection part 310 of the retaining member 300 may be welded to and coupled with the first uncoated part 212.

In some embodiment, the height of the retaining member 300 may be set to be equal to or higher than the height of the upper portion of the first portion 111 of the side wall 110.

The retaining member 300 may be inserted into the battery can 100 together with the electrode assembly 200 while being coupled to the electrode assembly 200. Alternatively, the retaining member 300 may be coupled after the electrode assembly 200 is inserted into the battery can 100.

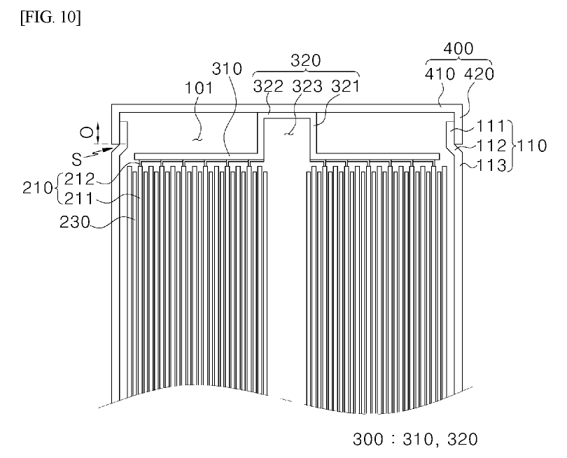

FIG. 10 is a view illustrating a state in which the cover cap 400 is coupled to the first portion 111 of the battery can 100.

Referring to FIG. 10, the cover cap 400 may be coupled to the first portion 111 formed on the upper portion of the side wall 110 of the battery can 100.

For example, the cover cap 400 may be fitted to the first portion 111. The edge part 420 of the cover cap 400 may be fitted to the upper portion of the first portion 111 and moved downward along the first portion 111.

For example, the inner circumferential surface of the edge part 420 of the cover cap 400 may slide along the outer circumferential surface of the first portion 111. The cover cap 400 may be restricted from downward movement when the lower end of the edge part 420 contacts the connection portion 112, which extends radially outward from the lower end of the first portion 111.

In the secondary battery 1 of the present disclosure, when the downward movement of the cover cap 400 is stopped and the cover cap 400 and the battery can 100 are coupled, at least a partial section of the edge part 420 of the cover cap 400 and at least a partial section of the first portion 111 of the side wall 110 may form the overlapping region O in which they overlap each other in the radial direction.

In this case, the overlapping region O may refer to a region where the inner circumferential surface of the edge part 420 and the outer circumferential surface of the first portion 111 are in surface contact. That is, in the present disclosure, the overlapping region O may be formed to extend in the axial direction.

In the secondary battery 1 of the present disclosure, the axially extending overlapping region O may be formed between the edge part 420 of the cover cap 400 and the first portion 111 of the battery can 100, and welding may be performed on the overlapping region O. For example, the secondary battery 1 may be welded on the overlapping region O from the radially outer side of the edge part 420.

In the present disclosure, since the overlapping region O may be formed in a partial section of the side wall 110 that occupies the largest area of the battery can 100, a sufficient welding area may be secured for welding with the cover cap 400.

In some embodiment, when the cover cap 400 is coupled to the first portion 111, the first electrolyte injection port 411 of the cover cap 400 and the second electrolyte injection port 3221 of the retaining member 300 may be disposed to communicate with each other.

For example, when the cover cap 400 is coupled to the first portion 111, the lower surface of the body part 410 and the upper surface of the support plate 322 of the cap connection part 320 may be in contact with each other. In this case, the lower surface of the body part 410 and the upper surface of the support plate 322 of the cap connection part 320 may be in surface contact. For example, the section where the body part 410 and the support plate 322 are in surface contact may be a portion excluding the first electrolyte injection port 411 and the second electrolyte injection port 3221, respectively.

For example, the body part 410 of the cover cap 400 and the cap connection part 320 of the retaining member 300 may be coupled by welding.

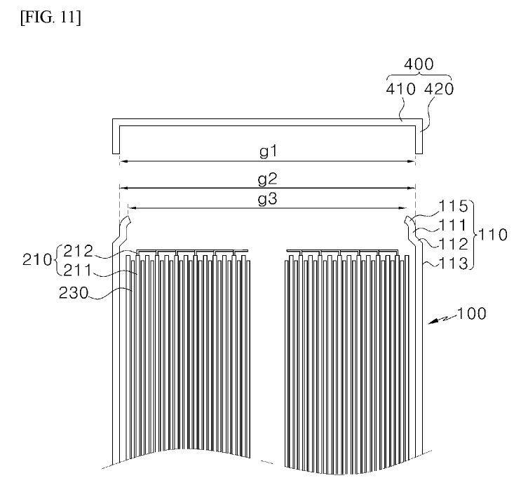

FIG. 11 is a view illustrating the structure of the side wall 110 according to some embodiment of the present disclosure.

Referring to FIG. 11, in some embodiment, the side wall 110 may comprise the guide part 115.

The guide part 115 may be disposed at an upper end of the first portion 111 having a first diameter. The guide part 115 may extend from the upper end of the first portion 111 and may be formed to curve toward the central axis of the battery can 100 as it approaches the body part 410. The guide part 115 may be formed to curve radially inward with a predetermined curvature as it extends axially upward from the upper end of the first portion 111.

In this case, an inner diameter g1 of the edge part 420 may be formed to be equal to or smaller than an outer diameter g2 of the first portion 111. In addition, the inner diameter g1 of the edge part 420 may be formed to be larger than an outer diameter (g3) of the end of the guide portion 115.

Accordingly, in the secondary battery 1 of the present disclosure, at the point where the edge part 420 begins to meet the side wall 110, since the outer diameter of the side wall 110 (e.g., the outer diameter g3 of the guide part 115) is smaller than the inner diameter g1 of the edge part 420, interference between the edge part 420 and the side wall 110 may be prevented, and the cover cap 400 may be easily coupled.

Thereafter, during the coupling process of the cover cap 400 to the battery can 100, as the lower end of the edge part 420 continues to move downward past the guide part 115, the lower end of the edge part 420 may come into contact with the first portion 111.

Since the inner diameter of the edge part 420 is formed to be equal to or smaller than the outer diameter of the first portion 111, the inner circumferential surface of the edge part 420 may slide downward along the outer circumferential surface of the first portion 111, and during this process, the cover cap 400 and the side wall 110 of the battery can 100 may be press-fitted together.

In this case, the overlapping region O of the present disclosure may be formed by surface contact between the outer circumferential surface of the first portion 111 excluding the guide part 115 and the inner circumferential surface of the edge part 420. In the present disclosure, the cover cap 400 may be welded to the overlapping region O formed in the first portion 111 of the battery can 100, excluding the guide part 115. For example, the welding process may be performed from the radially outer side of the edge part 420 that forms the overlapping region O with respect to the first portion 111.

It should be understood that the drawings described above are exaggerated in the size, length, and/or proportion of components to facilitate understanding of the present disclosure. For example, the height of the overlapping region O described in the present disclosure is exaggerated to facilitate understanding of the coupling structure between the cover cap 400 and the battery can 100. However, it should be understood that the overlapping region O of the present disclosure is formed at a height that does not impair the space efficiency of the battery can 100 and optimizes the energy efficiency of the secondary battery 1.

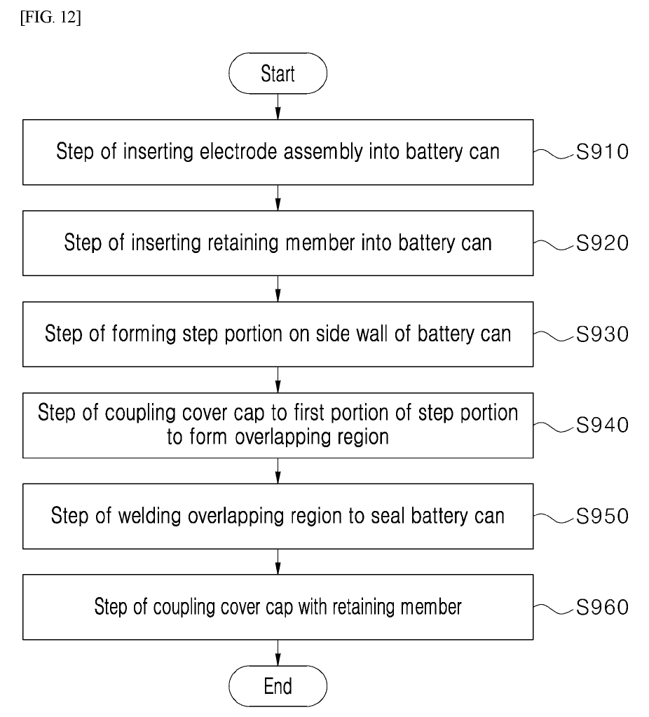

FIG. 12 is a flowchart illustrating a method for manufacturing the secondary battery 1 according to some embodiment of the present disclosure.

Referring to FIG. 12, the method for manufacturing the secondary battery 1 according to some embodiment of the present disclosure may comprise an electrode assembly insertion step (S910) of inserting the electrode assembly 200 into the battery can 100. For example, the electrode assembly insertion step (S910) may be performed prior to a step portion forming step (S930) described below. That is, the step portion forming step (S930) may be performed while the electrode assembly 200 is accommodated inside the battery can 100.

However, this is merely exemplary, and in various embodiments of the present disclosure, the order of the electrode assembly insertion step is not limited thereto. For example, the electrode assembly insertion step (S910) may be performed after the step portion forming step (S930).

The method for manufacturing the secondary battery 1 according to some embodiment of the present disclosure may further comprise a retaining member insertion step (S920) of inserting the retaining member 300 into the battery can 100. For example, in the retaining member insertion step (S920), the retaining member 300 may be seated on the upper portion of the electrode assembly 200 accommodated inside the battery can 100.

However, for convenience of description, the retaining member insertion step (S920) is described as a step portion Separate from the electrode assembly insertion step (S910). Nevertheless, this is merely exemplary, and the order of these steps is not limited thereto. For example, the retaining member insertion step (S920) may be performed simultaneously with the electrode assembly insertion step (S910).

In the method for manufacturing the secondary battery according to some embodiment, the retaining member insertion step (S920) and the electrode assembly insertion step (S910) may be performed simultaneously, in such a manner that the retaining member 300 is seated and coupled to the upper portion of the electrode assembly 200, and the electrode assembly 200 and the retaining member 300 are together housed inside the battery can 100.

Alternatively, in some embodiment, the retaining member insertion step (S920) may be performed after the electrode assembly insertion step (S910) and before the step portion S forming step (S930). For example, the secondary battery 1 may have the step portion S formed on the side wall 110 while the electrode assembly 200 is accommodated inside the battery can 100, and the retaining member 300 may be seated and coupled to the upper portion of the electrode assembly 200.

Alternatively, in some embodiment, the retaining member insertion step (S920) may be performed after the step portion forming step (S930). For example, the secondary battery 1 may have the electrode assembly 200 accommodated inside the battery can 100 and the step portion S formed on the side wall 110, and then the retaining member 300 may be seated and coupled to the upper portion of the electrode assembly 200.

The method for manufacturing the secondary battery 1 of the present disclosure may comprise the step portion S forming step (S930) of forming the step portion S so that the step portion S has different diameters with respect to the side wall 110 of the battery can 100.

In the step portion S forming step (S930), the first portion 111 having a first diameter smaller than the second diameter may be formed at a partial upper section of the side wall 110 of the battery can 100, which has a uniform second diameter throughout its entire length. Through the step portion S forming step (S930), the first portion 111 and the connection portion 112 may be formed on the side wall 110. For example, the step portion S forming step (S930) may be carried out through a swaging process, but is not limited thereto.

In some embodiment, the method for manufacturing the secondary battery 1 may further comprise a guide portion 115 forming step (S931) of additionally forming the guide portion 115 that curves radially inward as it extends upward from the upper end of the first portion 111 formed in the step portion S forming step (S930). For example, the step portion S forming step (S930) and the guide portion 115 forming step (S931) may be performed as a continuous process, but are not limited thereto.

The method for manufacturing the secondary battery 1 of the present disclosure may comprise an overlapping region O forming step (S940) of forming the overlapping region O by coupling the cover cap 400 to the first portion 111 of the side wall 110.

The overlapping region O may be formed by the outer circumferential surface of the first portion 111 of the side wall 110 and the inner circumferential surface of the edge part 420 of the cover cap 400 being in surface contact with each other. For example, in the overlapping region O forming step (S940), the edge part 420 of the cover cap 400 may be fitted to the first portion 111 of the side wall 110.

The method for manufacturing the secondary battery 1 may comprise a sealing step (S950) of sealing the cover cap 400 and the battery can 100 by welding the overlapping region O, once the overlapping region O is formed by coupling the first portion 111 and the cover cap 400. For example, the sealing step (S950) may be performed on the radially outer side of the edge part 420 that forms the overlapping region O with respect to the first portion 111.

In addition, the method for manufacturing the secondary battery 1 according to some embodiment of the present disclosure may further comprise an electrode fixing step (S960) of coupling the body part 410 of the cover cap 400 and the retaining member 300.

For example, the electrode fixing step (S960) may be performed by welding the second overlapping region O formed between the body part 410 of the cover cap 400 and the cap connection part 320.

For example, the electrode fixing step (S960) may be performed after the sealing step (S950) of coupling the cover cap 400 and the battery can 100, but is not limited thereto and may be performed before the sealing step (S950).

It should be understood that the order of each step of the method for manufacturing a secondary battery according to the various embodiments of the present disclosure described above is not limited. For example, it should be understood that at least two steps of the method for manufacturing a secondary battery comprised in the present disclosure may be performed simultaneously, or each step may be performed sequentially. The secondary battery 1 according to the various embodiments of the present disclosure described above may increase the space efficiency inside the battery can 100 by eliminating the beading part and the crimping part of the battery can 100.

In the present disclosure, the cover cap 400 is fitted to the battery can 100 to form the overlapping region O extending parallel to the axial direction, thereby generating and applying a primary fixing force to the cover cap 400.

Therefore, in the present disclosure, when the cover cap 400 is welded to the battery can 100, there is no need to apply a separate fixing force to secure an accurate welding area or to perform an additional process for fixing the cover cap 400.

Furthermore, in the present disclosure, by forming the overlapping region O in a partial section of the side wall 110 of the battery can 100 that extends in the axial direction, a sufficient welding area may be secured, thereby increasing the sealing strength of the cover cap 400.

In the above, although the embodiments of the present disclosure have been described with all components coupled in one or operating in combination, the present disclosure is not necessarily limited to such embodiments. Within the scope of the purpose of the present disclosure, all components may be selectively coupled in one or more forms and operate accordingly. Unless otherwise defined, all terms including technical or scientific terms have the same meanings as commonly understood by those skilled in the art to which the present disclosure pertains. Commonly used terms, such as those defined in dictionaries, should be interpreted in accordance with their contextual meanings in the relevant technical field, and unless explicitly defined in the present disclosure, shall not be interpreted in an idealized or unduly formal sense.

The above description is merely illustrative of the technical spirit of the present disclosure, and it will be appreciated by those skilled in the art to which the present disclosure pertains that various modifications and variations can be made without departing from the essential characteristics of the present disclosure. Therefore, the embodiments disclosed herein are intended to describe, not to limit, the technical spirit of the present disclosure, and the scope of the technical spirit is not limited to these embodiments. The scope of protection of the present disclosure shall be defined by the following claims, and all technical spirits that fall within the equivalent scope shall be construed as being comprised within the scope of the present disclosure.

What is claimed is:

1. A secondary battery comprising:
a battery can including a side wall; and
a cover cap coupled to one side of the side wall,
wherein at least a partial section of the cover cap is disposed to overlap the side wall in a radial direction to form an overlapping region, and
wherein the cover cap and the battery can are coupled in the overlapping region.

2. The secondary battery according to claim 1, wherein the cover cap comprises a body part disposed to cover an opening formed in one side of the side wall, and an edge part extending from the body part and disposed to overlap the side wall.

3. The secondary battery according to claim 2, wherein the overlapping region is formed by the edge part and the side wall being arranged parallel to each other in an axial direction.

4. The secondary battery according to claim 2, wherein an upper end of the side wall is axially spaced from the body part.

5. The secondary battery according to claim 2, wherein the side wall comprises a first portion disposed to overlap at least a partial section of the edge part, and a second portion having a diameter larger than that of the first portion and formed in a stepped structure from the first portion.

6. The secondary battery according to claim 5, wherein the cover cap is fitted to the first portion.

7. The secondary battery according to claim 5, wherein the overlapping region is formed by surface contact between at least a portion of an inner circumferential surface of the edge part and at least a portion of an outer circumferential surface of the first portion, and
wherein the cover cap and the battery can are joined to each other by welding on a radially outer side of the overlapping region.

8. The secondary battery according to claim 5, wherein the side wall comprises a guide part extending from an upper end of the first portion and curved toward a central axis of the battery can as it approaches the body part.

9. The secondary battery according to claim 5, wherein the side wall comprises a connection portion connecting the first portion and the second portion, and
wherein the edge part is restricted from downward movement by the connection portion.

10. The secondary battery according to claim 5, wherein an inner diameter of the edge part is formed to be equal to or smaller than an outer diameter of the first portion.

11. The secondary battery according to claim 8, wherein an inner diameter of the edge part is formed to be larger than an outer diameter of an end of the guide part.

12. The secondary battery according to claim 5, comprising an electrode assembly disposed on an inner side of the side wall, and a retaining member disposed between the electrode assembly and the cover cap to support the electrode assembly.

13. The secondary battery according to claim 12, wherein the retaining member electrically connects the electrode assembly to the cover cap.

14. The secondary battery according to claim 12, wherein the retaining member comprises an electrode connection part coupled to an upper end of the electrode assembly, and a cap connection part protruding from the electrode connection part and coupled to the body part.

15. The secondary battery according to claim 14, wherein at least a partial section of an edge of the electrode connection part is disposed to support an inner circumferential surface of the first portion.

16. The secondary battery according to claim 14, wherein the cap connection part comprises a support wall protruding axially upward from the electrode connection part, and a support plate disposed at an upper end of the support wall and connected to the body part.

17. The secondary battery according to claim 16, wherein a first electrolyte injection port penetrating vertically is formed on one side of the body part, and
a second electrolyte injection port communicating with the first electrolyte injection port is formed on one side of the support plate.

18. A method for manufacturing a secondary battery, comprising:
an electrode assembly insertion step of inserting an electrode assembly into a battery can;
a step portion forming step of forming a step portion having different diameters with respect to a side wall of the battery can;
an overlapping region forming step of forming an overlapping region by coupling a cover cap to a first portion of the step portion; and
a sealing step of welding the overlapping region to seal the cover cap and the battery can.

19. The method according to claim 18, wherein in the sealing step, the cover cap and the battery can are joined to each other by welding on a radially outer side of the overlapping region.

20. The method according to claim 18, further comprising:
a retaining member insertion step of disposing a retaining member on an upper portion of the electrode assembly inside the battery can; and
an electrode fixing step of coupling the retaining member and the cover cap.
